(19) United States
(12) Patent Application Publication
(10) Pub. No.: US 2017/0140618 A1
(43) Pub. Date: May 18, 2017

(54) WEARABLE COMPUTING DEVICE

(71) Applicant: International Business Machines Corporation, Armonk, NY (US)

(72) Inventors: Eli M. Dow, Wappingers Falls, NY (US); Thomas D. Fitzsimmons, Poughkeepsie, NY (US); Tynan J. Garrett, Poughkeepsie, NY (US); Emily M. Metruck, Poughkeepsie, NY (US)

(21) Appl. No.: 14/940,492

(22) Filed: Nov. 13, 2015

(51) Int. Cl. G08B 6/00

(52) U.S. Cl. CPC G08B 6/00

(57) ABSTRACT

A method of operation of a wearable device comprises receiving a notification time in a processor, determining whether a current time is the notification time, and emitting a vibratory signal indicative of the notification time responsive to determining that the current time is the notification time.

### BACKGROUND

The present invention relates to wearable computer devices, and more specifically, to wearable computer device functions and operations.

Wearable computing devices include such devices as watches, glasses, jewelry, rings, and other devices that may be worn by a user. Wearable computing devices may communicatively connect to other portable or non-portable devices that are in the vicinity of the user or may connect to other computing devices or servers over a wireless communicative connection.

Wearable computing devices often include a display that may be backlit. Users may interact and provide input to the wearable computing devices using various input methods and devices including touch screens, buttons, scroll wheels, motion, or voice. Some wearable computing devices may include mechanisms that vibrate and provide tactile feedback to a user. Wearable devices may also include cameras.

As wearable computing devices become more useful by providing more features and operability, the interaction between a user and the wearable computing devices becomes more important.

### SUMMARY

According to an embodiment of the present invention, a method of operation of a wearable device comprises receiving a notification time in a processor, determining whether a current time is the notification time, and emitting a vibratory signal indicative of the notification time responsive to determining that the current time is the notification time.

According to another embodiment of the present invention, a wearable device comprises a vibration emitting portion, and a processor operative to receive a notification time in a processor, determine whether a current time is the notification time, and emit a vibratory signal indicative of the notification time responsive to determining that the current time is the notification time.

According to yet another embodiment of the present invention, a wearable device comprises a display, a sensor, and a processor communicably connected to the display and the sensor, the processor operative to receive a signal from the sensor, process the signal to calculate an orientation of the display relative to a face of a user, determine whether the display is visible to the user, and activate the display responsive to determining that the display is visible to the user.

### BRIEF DESCRIPTION OF THE DRAWINGS

FIG. 1 illustrates a block diagram of a wearable computing device.

FIG. 2 illustrates an exemplary embodiment of a device of FIG. 1.

FIG. 3 illustrates a side cut-away view of the device of FIG. 2.

FIG. 4 illustrates a flow diagram of an exemplary method of operation of the device of FIG. 2.

FIG. 5 illustrates a flow diagram of another exemplary method of operation of the device of FIG. 2.

### DETAILED DESCRIPTION

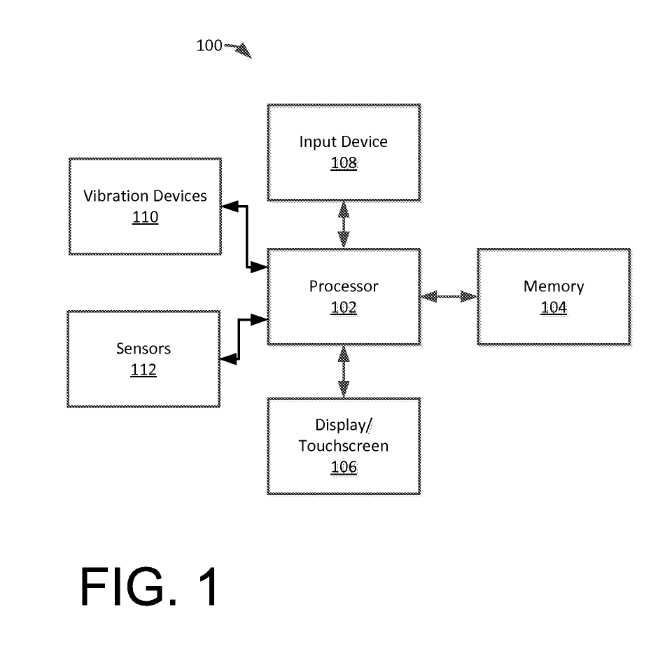

FIG. 1 illustrates a block diagram of a wearable computing device (device) 100. The device 100 includes a processor 102 that is communicably connected to a memory portion 104, a display portion 106, an input device 108, a vibration device 110 and sensors 112.

The display portion 106 may include any type of display that is operable to present information to a user. The display portion 106 may be a touch screen type device that receives touch inputs from the user when the user touches the screen. The display portion 106 may also include a backlight feature such that the display may be seen by the user in the dark or under other lighting conditions. The input device 108 may include the display 106 or other input devices that include, for example, scroll wheels, buttons, switches, microphones, cameras, or any other type of input device that is operative to receive user input. The vibration device 110 may include any type of electronic, electromechanical, or mechanical device that is operative to provide sensory feedback that may be felt by a user. In this regard, the vibration device 110 may include one or more motors having a weight attached to a rotational axis such that when activated the motor spins the weight and imparts a vibration in the device 100. Linear actuators or other types of electrical or electromechanical devices may also be used to impart feedback to the user. In some embodiments, the vibration device 110 may be arranged to minimize the noise emitted by the vibration device 100 such that the vibration device 110 is less audible to the user. Sensors 112 may include any suitable type of sensor or combination of sensors including, for example, cameras, inferred sensors, proximity sensors, microphones, audio sensors, gyro sensors, impact sensors, pressure sensors, voltage sensors, capacitive sensors, or thermal sensors.

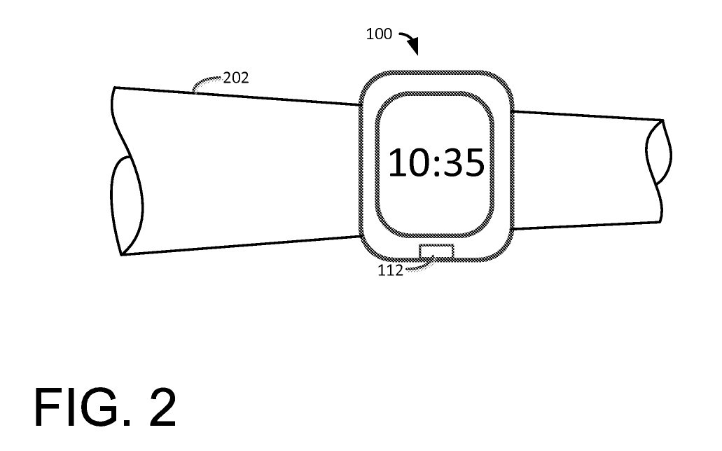

FIG. 2 illustrates an exemplary embodiment of a device 100 that is similar to a watch that includes the components described in FIG. 1. The device 100 is worn on a wrist 202 of a user. The device 100 in FIG. 2 is shown as a watch however, alternate exemplary embodiments may include any type of wearable device.

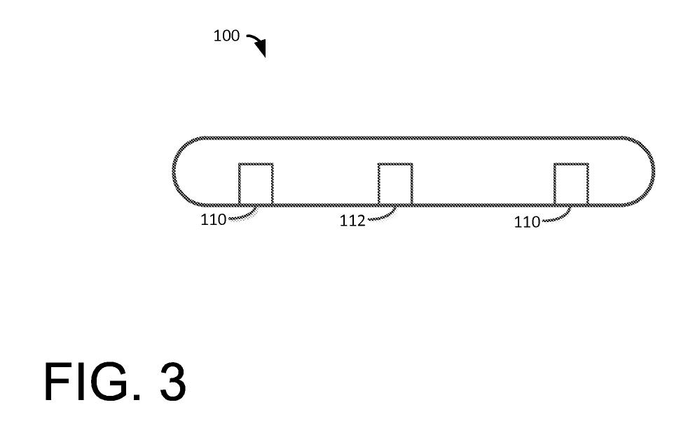

FIG. 3 illustrates a side cut-away view of the device 100 that includes the vibration devices 110 and sensors 112. The device 100 may include any number or combination of sensors 112 and vibration devices 110.

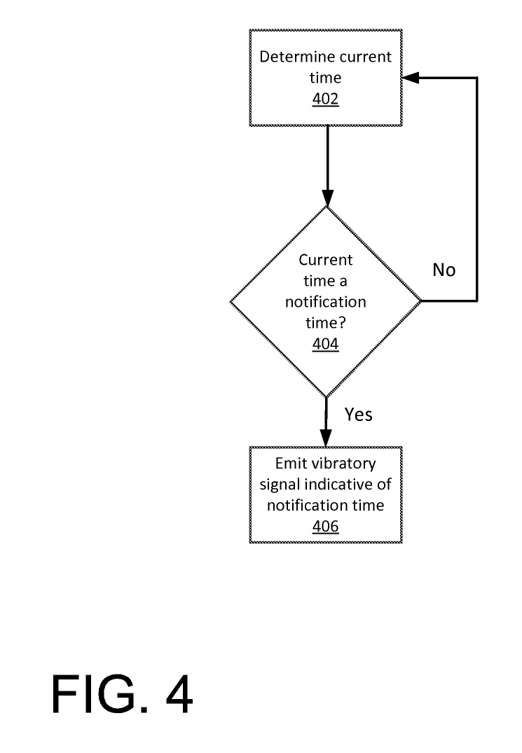

FIG. 4 illustrates a flow diagram of an exemplary method of operation of the device 100 (of FIG. 1). The exemplary method provides a user feedback that is indicative of the time. For example, the vibration device 110 of the device 100 may vibrate or pulse to indicate the time thereby, the user may know the time without looking at the device 100. The device 100 may emit a pulsed vibration or pattern that is indicative of the time. Further, the display 106 may remain in a dormant or “sleep” state where the backlighting on the display 106 may remain off, which may reduce power consumption, and reduce distractions to the user and other people in the vicinity of the user due to the lighting of the backlight.

In this regard, referring to FIG. 4, in block 402 the device 100 determines the current time of day (time). In block 404, the device 100 determines whether the current time is a designated notification time, which may be set by the user in advance. For example, the user may set the device 100 to emit a notification every hour on the hour, a notification on the hour within a time window such as during daytime, or a notification on the hour and half hour or quarter hour.

If the current time is a notification time, the device 100 via the vibration device 110 will emit a vibratory signal indicative of the notification time. Thus, if the user designates every hour on the hour as a notification time, the device 100 will emit a vibratory signal every hour on the hour that indicates the time. Such a signal may include, for example, a number of pulses that corresponds to the notification time, where 1 PM is associated with a single pulse, 2 PM is associated with two pulses, 3 PM is associated with three pulses, and so on. Since the user may designate what times are notification times, the user may set the device 100 to not emit a vibratory signal during certain times or windows of time (e.g., during bedtime). Though the exemplary embodiments describe one pulse scheme for vibratory signals that indicate the notification time, any other suitable pulsing scheme may be used to indicate a particular notification time.

As discussed above, the device 100 may include a backlit display 106 or other type of display that is operative to emit light when the display 106 is presenting content to a user. In some previous devices, the display 106 may illuminate when the display 106 or other input devices 108 receive an input by the user, for example, when a user touches the display 106. However, such a mode of operation may be inconvenient, and thus it is desirable for the display 106 to illuminate in some modes of operation without the user touching an input device 108 of the device, which may include the display 106.

In this regard, the device 100 includes the sensors 112 that may include, for example, a camera or motion sensors that sense the motion, acceleration, orientation, or location of the device 100. The sensors 112 may operate independently or together to send signals to the processor 102 that may be processed to determine an orientation of the device 100 relative to the eyes or other body part of the user.

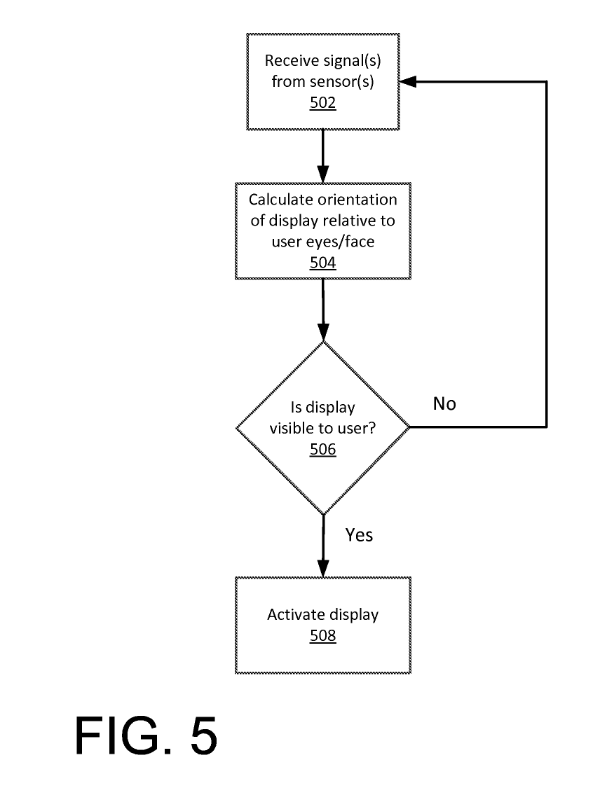

FIG. 5 illustrates a flow diagram of an exemplary method of operation of the device 100 (of FIG. 1). Referring to FIG. 5, in block 502 the processor 102 receives one or more signals from the sensor(s) 112. In block 504, the device 100 determines the orientation of the display 106 relative to the face or eyes of the user. The device 100 may determine the orientation of the display relative to the face or eyes of the user by any number of methods. For example, the sensor 112 may include a camera that uses an image, series of images, or video to determine the orientation of the display 106 relative to the face or eyes of the user. In such an exemplary embodiment, the camera may use facial recognition or other image or video analysis. In another exemplary embodiment, the device 100 may use sensors 112 that include accelerometers that may determine the acceleration of the device 100 and the orientation of the display 106 relative to the face of the user. In one exemplary embodiment, detection of the orientation of the display 106 relative to the face of the user may be determined by detecting with the accelerometers a sudden or sustained vertical acceleration of the device substantially along a vertical axis for a given distance, e.g., twelve inches, and a rotation of the device about the vertical axis of approximately 90 degrees. The vertical axis is substantially collinear with the spine of the user.

In block 506, the processor 102 determines whether the display 106 is visible to the user. In this regard, after the processor 102 has determined the orientation of the display relative to the eyes or face of the user, the processor 102 may determine whether the display 106 is in a position relative to the face or eyes of the user that is visible to the user. Whether the position of the display 106 relative to the face or eyes of the user is in a position visible to the user may be determined by, for example, determining the line of sight of the user and determining whether the display 106 is within the line of sight of the user.

In block 506 the processor 102 activates the display. The activation of the display may include, for example, illuminating the display by activating back lighting on the display, or any other function that includes displaying content or data on the display.

The methods and systems described above provide a wearable device that is operative to provide vibratory output that may be felt by a user that indicates a current time to a user. The methods and systems further provide for a wearable device that is operative to determine a relative position of the display with respect to the line of sight, face or eyes of a user and activate the display when the device determines that the display is in a position viewable to the user.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method of operation of a wearable device, the method comprising:
receiving a notification time in a processor;
determining whether a current time is the notification time; and
emitting a vibratory signal indicative of the notification time responsive to determining that the current time is the notification time, wherein the vibratory signal includes a series of pulses.

2. The method of claim 1, wherein the series of pulses corresponds to the time such that the series of pulses expresses the notification time to a user.

3. The method of claim 2, wherein the series of pulses corresponding to the time includes a pulse for each previous hour in the day and the current hour.

4. The method of claim 1, wherein the time is a time of day.

5. The method of claim 1, wherein the notification time is set by a user.

6. The method of claim 1, wherein the vibratory signal is emitted by a linear actuator.

7. The method of claim 1, wherein the vibratory signal is emitted by a rotating motor.

8. A wearable device comprising:
a vibration emitting portion; and
a processor operative to:
receive a notification time in a processor;
determine whether a current time is the notification time; and
emit a vibratory signal indicative of the notification time responsive to
determining that the current time is the notification time, wherein the vibratory signal includes a series of pulses.

9. The device of claim 8, wherein the series of pulses, corresponds to the time such that the series of pulses expresses the notification time to a user.

10. The device of claim 9, wherein the series of pulses corresponding to the time includes a pulse for each previous hour in the day and the current hour.

11. The device of claim 8, wherein the time is a time of day.

12. The device of claim 8, wherein the notification time is set by a user.

13. The device of claim 8, wherein the vibration emitting portion includes a linear actuator.

14. The device of claim 8, wherein the vibration emitting portion includes a rotating motor.

15. A wearable device comprising:
a display;
a sensor; and
a processor communicably connected to the display and the sensor, the processor operative to:
receive a signal from the sensor;
process the signal to calculate an orientation of the display relative to a face of a user;
determine whether the display is visible to the user; and
activate the display responsive to determining that the display is visible to the user.

16. The device of claim 15, wherein the display is operative to emit light that presents content to a user on the display.

17. The device of claim 15, wherein the sensor includes a camera operative to capture an image and output the image as the signal to the processor.

18. The device of claim 15, wherein the sensor includes an accelerometer operative to sense acceleration of the device.

19. The device of claim 15, wherein the display is visible to the user when the display is within a line of sight of the user.

20. The device of claim 15, wherein the device is operative to be worn on a wrist of the user.
